(19) United States
(12) Patent Application Publication
(10) Pub. No.: US 2015/0220920 A1
(43) Pub. Date: Aug. 6, 2015

(54) METHOD AND SYSTEM FOR OPTIMIZING FORCE POSTED PAYMENTS

(71) Applicant: MasterCard International Incorporated, Purchase, NY (US)

(72) Inventor: Justin X. HOWE, San Francisco, CA (US)

(73) Assignee: MasterCard International Incorporated, Purchase, NY (US)

(21) Appl. No.: 14/169,802

(22) Filed: Jan. 31, 2014

(51) Int. Cl. G06Q 20/40

(52) U.S. Cl. CPC G06Q 20/40

(57) ABSTRACT

A method for force posting clearing transactions includes: storing, in a memory, a chargeback ratio associated with a merchant and a chargeback threshold; receiving, by a receiving device, a plurality of declined authorization requests, wherein each declined authorization request is associated with a payment transaction involving the merchant; identify, for each of the received declined authorization requests, a fraud or chargeback score, wherein the fraud or chargeback score represents a likelihood of the associated payment transaction being fraudulent or charged back; identifying, by a processing device, a subset of declined authorization requests where each declined authorization request included in the subset is based on the respective identified fraud or chargeback score, wherein a number of declined authorization requests in the subset is based on a correspondence between the chargeback ratio and the chargeback threshold; and submitting a clearing record for each declined authorization request in the identified subset.

### FIELD

The present disclosure relates to the forced posting of clearing records, specifically the use of optimization to identify declined authorization requests for force post clearing based on fraud or chargeback scores.

### BACKGROUND

During the processing of payment transactions, there may be instances where a clearing record cannot be matched to an authorization request. In such an instance, the clearing record may be submitted by a payment processor (e.g., a payment network) without a corresponding approved authorization request. This capability is leveraged for a class of transactions called “force posted transactions.” Force Posting is the submission of a clearing record to a payment network despite receiving an authorization decline, and is done solely at the merchant or acquirer's discretion (usually based on familiarity with the consumer, or after verifying the cardholder with the issuer over the phone). Often times, clearing records that are force posted may result in a higher interchange rate for the corresponding merchant.

However, for many merchants, particularly merchants with a high profit margin, such as merchants dealing in digital goods or subscription services, the increased processing costs for the force posting of a clearing record is significantly exceeded by the high profit margin. As a result, these types of merchants could benefit from the forced posting of denied authorization requests. However, force posting denied authorization requests could also result in an increase in the number of chargebacks, such as in instances where an authorization request was denied for suspicion of fraud. An increase in the number of chargebacks can result in a loss of revenue, additional chargeback fees or, in extreme cases, the merchant may even have their access to a payment network shut off by the network if the number of chargebacks grows too high.

Thus, the present inventor believes there is a need for a technical solution to identify denied authorization requests for force post clearing to increase merchant revenue while maintaining an acceptable level of chargebacks.

### SUMMARY

The present disclosure provides a description of systems and methods for force posting clearing transactions.

A method for force posting clearing transactions includes: storing, in a memory, a chargeback ratio associated with a merchant and a chargeback threshold; receiving, by a receiving device, a plurality of declined authorization requests, wherein each declined authorization request is associated with a payment transaction involving the merchant; identify, for each of the received declined authorization requests, a fraud or chargeback score, wherein the fraud or chargeback score represents a likelihood of the associated payment transaction being fraudulent or charged back; identifying, by a processing device, a subset of declined authorization requests where each declined authorization request included in the subset is based on the respective identified fraud or chargeback score, wherein a number of declined authorization requests in the subset is based on a correspondence between the chargeback ratio and the chargeback threshold; and submitting, by a transmitting device, a clearing record for each declined authorization request in the identified subset.

A system for force posting clearing transactions includes a memory, a receiving device, a processing device, and a transmitting device. The memory is configured to store a chargeback ratio associated with a merchant and a chargeback threshold. The receiving device is configured to receive a plurality of declined authorization requests, wherein each declined authorization request is associated with a payment transaction involving the merchant. The processing device is configured to: identify, for each of the received declined authorization requests, a fraud or chargeback score, wherein the fraud or chargeback score represents a likelihood of the associated payment transaction being fraudulent or charged back; and identify a subset of declined authorization requests where each declined authorization request included in the subset is based on the respective identified fraud or chargeback score, wherein a number of declined authorization requests in the subset is based on a correspondence between the chargeback ratio and the chargeback threshold. The transmitting device is configured to submit a clearing record for each declined authorization request in the identified subset.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for force posting clearing transactions in accordance with exemplary embodiments.

FIG. 2 is a block diagram illustrating the processing server of FIG. 1 for the force posting of clearing transactions using optimization techniques in accordance with exemplary embodiments.

FIG. 3 is a flow diagram illustrating a process for identifying denied authorization requests for force posting in accordance with exemplary embodiments.

FIG. 4 is a flow diagram illustrating a process for force posting clearing transactions using the processing device of FIG. 2 in accordance with exemplary embodiments.

FIG. 5 is a flow chart illustrating an exemplary method for force posting clearing transactions in accordance with exemplary embodiments.

FIG. 6 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Definition of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard ®, VISA®, Discover®, American Express®, PayPal , etc. Use of the term “payment network” herein may refer to both the payment network as an entity, and the physical payment network, such as the equipment, hardware, and software comprising the payment network.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require and special knowledge in offered products. In some embodiments, an entity involved in a single transaction may be considered a merchant.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account, and may be drawn on by the beneficiary via the use of a payment card. An issuer may also offer additional types of payment accounts to consumers as will be apparent to persons having skill in the relevant art, such as debit accounts, prepaid accounts, electronic wallet accounts, savings accounts, checking accounts, etc., and may provide consumers with physical or non-physical means for accessing and/or utilizing such an account, such as debit cards, prepaid cards, automated teller machine cards, electronic wallets, checks, etc.

Acquirer—An entity that may process payment card transactions on behalf of a merchant. The acquirer may be a bank or other financial institution authorized to process payment card transactions on a merchant's behalf. In many instances, the acquirer may open a line of credit with the merchant acting as a beneficiary. The acquirer may exchange funds with an issuer in instances where a consumer, which may be a beneficiary to a line of credit offered by the issuer, transacts via a payment card with a merchant that is represented by the acquirer.

Payment Transaction—A transaction between two entities in which money or other financial benefit is exchanged from one entity to the other. The payment transaction may be a transfer of funds, for the purchase of goods or services, for the repayment of debt, or for any other exchange of financial benefit as will be apparent to persons having skill in the relevant art. In some instances, payment transaction may refer to transactions funded via a payment card and/or payment account, such as credit card transactions. Such payment transactions may be processed via an issuer, payment network, and acquirer. The process for processing such a payment transaction may include at least one of authorization, batching, clearing, settlement, and funding. Authorization may include the furnishing of payment details by the consumer to a merchant, the submitting of transaction details (e.g., including the payment details) from the merchant to their acquirer, and the verification of payment details with the issuer of the consumer's payment account used to fund the transaction. Batching may refer to the storing of an authorized transaction in a batch with other authorized transactions for distribution to an acquirer. Clearing may include the sending of batched transactions from the acquirer to a payment network for processing. Settlement may include the debiting of the issuer by the payment network for transactions involving beneficiaries of the issuer. In some instances, the issuer may pay the acquirer via the payment network. In other instances, the issuer may pay the acquirer directly. Funding may include payment to the merchant from the acquirer for the payment transactions that have been cleared and settled. It will be apparent to persons having skill in the relevant art that the order and/or categorization of the steps discussed above performed as part of payment transaction processing.

### System for Force Posting Clearing Transactions

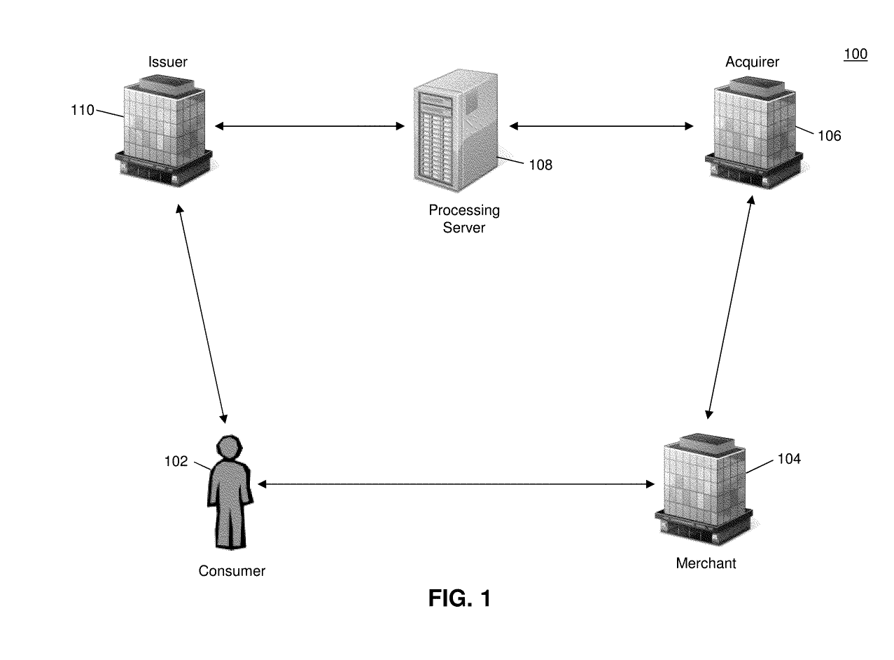

FIG. 1 illustrates a system 100 for the force posting of clearing transactions based on optimization using fraud or chargeback scoring.

The system 100 may include a consumer 102. The consumer 102 may initiate a payment transaction with a merchant 104. The payment transaction may be any type of payment transaction suitable for performing the functions as disclosed herein, such as an in-person transaction, a remote transaction, an Internet transaction, etc. As part of the processing of the payment transaction, the merchant 104 may transmit transaction data for the payment transaction to an acquirer 106, such as an acquiring bank. The acquirer 106 may generate an authorization request for the payment transaction, and submit the authorization request to a processing sever 108, which may be operating as part of a payment network.

The processing server 108 may process the payment transaction using methods and systems that will be apparent to persons having skill in the relevant art. Processing of the payment transaction may include transmitting transaction data included in the authorization request to an issuer 110 associated with the consumer 102 for approval or denial. The issuer 110 may be a financial institution, such as an issuing bank, associated with the consumer 102 that issued a payment instrument (e.g., payment card, check, etc.) to the consumer 102 for use in funding the payment transaction.

The issuer 110 may approve or deny the payment transaction using methods and systems that will be apparent to persons having skill in the relevant art. The issuer 110 may transmit a response to the processing server 108 indicating approval or denial of the transaction. The processing server 108 may transmit a corresponding authorization response, based on the indication, to the acquirer 106, who may forward the response to the merchant 104 for finalization of the transaction. Finalization of the transaction may include communicating a denial of the transaction to the consumer 102 if the issuer 110 indicates that the transaction is denied, or the furnishing of the transacted-for goods or services if the issuer 110 indicates that the transaction is approved.

In instances where the issuer 110 denies the payment transaction, the processing server 108 may be configured to force post a clearing record associated with the transaction despite the denial. As discussed in more detail below, the processing server 108 may be configured to optimize denied authorization requests for force posting based on a fraud or chargeback score. The fraud or chargeback score may represent the likelihood that the corresponding payment transaction is fraudulent and/or will be charged back. In some instances, the fraud or chargeback score for a payment transaction may be identified prior the transmitting of corresponding transaction data to the issuer 110, such as for use by the issuer 110 in approving or denying the transaction.

The processing server 108 may identify a number of denied authorization requests based on a chargeback threshold associated with the merchant 104 and/or acquirer 106. The chargeback threshold may be set by a payment network (e.g., the processing server 108 or a payment network to which the processing server 108 is associated) and may be a ratio of chargebacks to total transactions for the associated merchant 104 and/or acquirer 106. The processing server 108 may identify the specific number of denied authorization requests, with those requests identified being based on the associated fraud or chargeback scores. The processing server 108 may then force post the clearing records associated with the identified denied authorization requests.

By force posting only a portion of the denied authorization requests based on a chargeback threshold, the processing server 108 may process additional transactions for a merchant 104 without placing the merchant 104 at risk of facing repercussions with a payment network. In addition, the optimization of denied authorization requests for force posting based on fraud or chargeback scores may enable the processing server 108 to force post clearing records for payment transactions with the highest likelihood of being genuine, and thus a higher likelihood that no chargeback will be submitted by the consumer 102 for each transaction. This can, in turn, result in increased revenue for the merchant 104 and/or acquirer 106 with a minimal increase in chargebacks.

### Processing Server

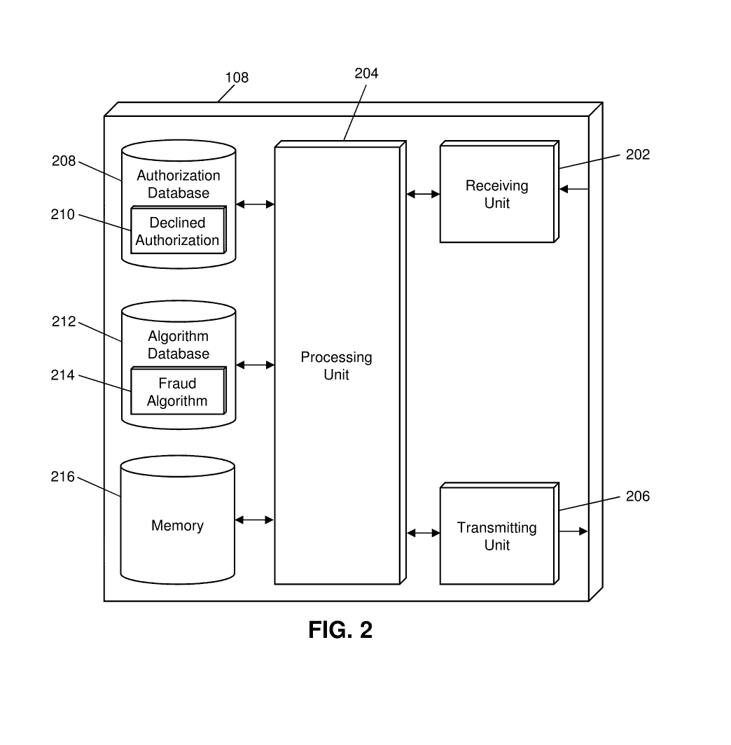

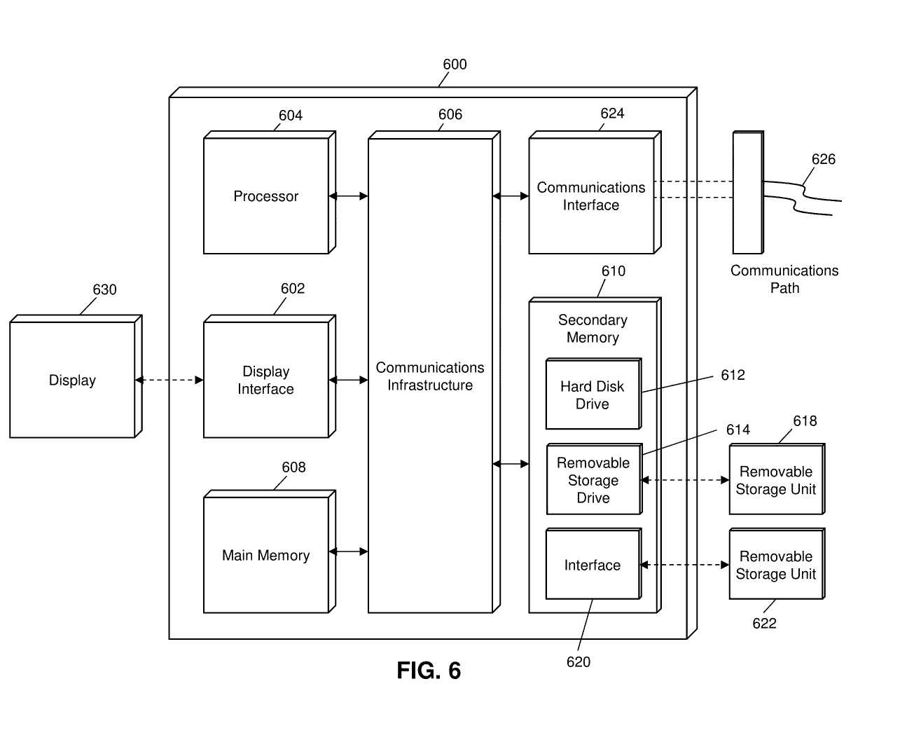

FIG. 2 illustrates an embodiment of the processing server 108 of the system 100. It will be apparent to persons having skill in the relevant art that the embodiment of the processing server 108 illustrated in FIG. 2 is provided as illustration only and may not be exhaustive to all possible configurations of processing server 108 suitable for performing the functions as discussed herein. For example, the computer system 600 illustrated in FIG. 6 and discussed in more detail below may be a suitable configuration of the processing server 108.

The processing server 102 may include a receiving unit 202. The receiving unit 202 may be configured to receive data over one or more networks via one or more network protocols. The receiving unit 202 may receive authorization requests from acquirers 106 and/or merchants 104. The receiving unit 202 may also receive responses from the issuer 110 indicating approval or denial of corresponding payment transactions. The receiving unit 202 may also be configured to receive data from additional sources, such as a payment network, such as data suitable for the identification of fraud or chargeback scores, as discussed in more detail below. [0030]The processing server 108 may also include a transmitting unit 206. The transmitting unit 206 may be configured to transmit transaction data included in an authorization request and/or the authorization request itself to the issuer 110. The transmitting unit 206 may also be configured to transmit authorization responses regarding payment transactions to the acquirer 106 and/or merchant 104 in response to received authorization requests. The transmitting unit 206 may be further configured to submit identified clearing records for declined authorization requests using force posting.

The processing unit 208 may further include a processing unit 204. The processing unit 204 may be configured to generate authorization responses based on approvals or denials received from the issuer 110 for payment transactions. The processing unit 204 may also be configured to store authorization requests for declined transactions in an authorization database 208 as declined authorizations 210. The processing unit 208 may be configured to identify fraud or chargeback scores for each declined authorization 210. In some embodiments, the processing unit 208 may identify fraud or chargeback scores for every received authorization request.

The fraud or chargeback scores may be calculated using one or more fraud algorithms 214 stored in an algorithm database 212 of the processing server 108. The fraud algorithms 214 may be algorithms suitable for identifying the likelihood that a payment transaction will be fraudulent or charged back. The fraud algorithms 214 may utilize transaction data (e.g., included in the authorization request) and any other data suitable for identifying a fraud or chargeback score, such as fraud data, approved authorization requests, e-commerce session data, historical account data, device data, or other suitable data as will be apparent to persons having skill in the relevant art.

The processing unit 204 may be configured to optimize the declined authorizations 210 stored in the authorization database 208 based on the associated fraud or chargeback scores. In some instances, the optimization of the declined authorizations 210 may be further based on a transaction amount for each payment transaction (e.g., included in the authorization request). In some embodiments, the processing unit 204 may utilize one or more optimization models, which may be stored in a memory 216 of the processing server 108. The optimization models may utilize linear programming, integer programming, non-linear programming, or other suitable principles of optimization.

The processing unit 204 may identify a subset of the declined authorizations 210 in the authorization database 208 for force post clearing. The number of declined authorizations 210 included in the subset may be based on a chargeback ratio for the corresponding merchant 104 and/or acquirer 106 and a chargeback threshold. The chargeback ratio and chargeback threshold may be stored in the memory 216. The identified subset of declined authorizations 210 may then be made available for force post clearing via the transmitting unit 206. In some embodiments, the processing unit 204 may be configured to estimate the chargeback ratio for the merchant 104, such as based on transaction data received by the receiving unit 202.

### Process for Force Posting Clearing Records

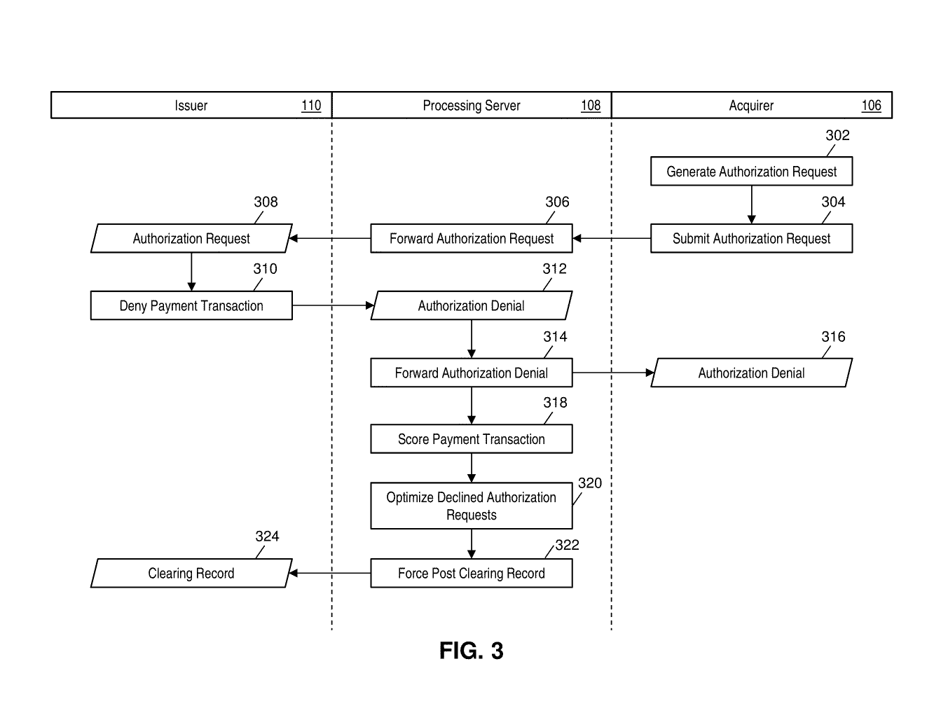

FIG. 3 illustrates a process for the force posting of clearing records for declined authorization requests based on fraud or chargeback score optimization and chargeback ratio.

In step 302, the acquirer 106 associated with the merchant 104 may generate an authorization request for a payment transaction involving the merchant 104 and the consumer 102. The authorization request may include transaction data associated with the payment transaction, such as a transaction amount, transaction time and/or date, payment data, consumer data, merchant data, etc. In step 304, the acquirer 106 may submit the authorization request to the processing server 108 for processing. The processing server 108 may receive (e.g., via the receiving unit 202) the authorization request and forward, in step 306, the authorization request and/or transaction data included therein to the issuer 110. In step 308, the issuer 110 may receive the forwarded authorization request.

In step 310, the issuer 110 may deny the payment transaction. The payment transaction denial may be transmitting to the processing server 108, which may receive (e.g., via the receiving unit 202) the transaction denial in step 312. In step 314, the transmitting unit 206 of the processing server 108 may transmit an authorization denial to the acquirer 106, who may receive the denial, in step 316. In step 318, the processing unit 204 of the processing server 108 may score the payment transaction, such as by using one or more fraud algorithms 214 stored in the algorithm database 212. In step 320, the processing server 108 may optimize the declined authorizations 210 stored in the authorization database 208 including the newly scored declined authorization request.

In step 322, the transmitting unit 206 of the processing server 108 may force post the clearing record for the payment transaction based on the optimization performed in step 320 and the chargeback ratio for the merchant 104 and chargeback threshold. In step 324, the issuer 110 may receive the clearing record for the payment transaction as a result of the force posting of the record by the processing server 108. In some embodiments, steps 318 through 324 may take place one or more days following the execution of steps 302 through 316, which may coincide with the regular processing (e.g., authorization, clearing, settling, etc.) of payment transactions.

### Process for Identifying Clearing Records for Force Posting

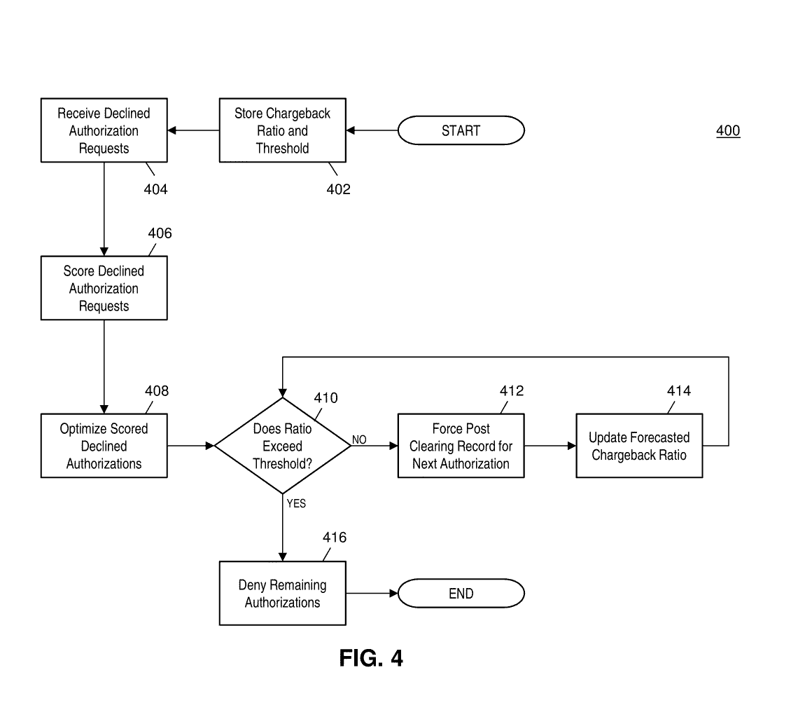

FIG. 4 illustrates a process 400 for the identification of clearing records associated with declined authorization requests for force posting based on optimization and chargeback ratios and thresholds.

In step 402, the processing unit 204 of the processing server 108 may store a chargeback ratio and chargeback threshold in the memory 216. The chargeback ratio may be a ratio of chargebacks for the merchant 104 to total transactions involving the merchant 104. The chargeback threshold may be set by a payment network (e.g., the processing server 108) and may be a threshold for the chargeback ratio that, if exceeded, may result in negative consequences for the merchant 104.

In step 404, the receiving unit 202 may receive declined authorization requests, which may be stored as declined authorizations 210 in the authorization database 208. The declined authorizations 210 may be received as part of the normal course of transaction processing, such as by processing a plurality of payment transactions and storing the authorization requests for declined payment transaction as the declined authorizations 210 in the authorization database 208.

In step 406, the processing unit 204 may score the declined authorizations 210 by identifying a fraud or chargeback score for each. The fraud or chargeback score may represent a likelihood of the associated payment transaction being fraudulent or a chargeback. The fraud or chargeback score may be identified using one or more fraud algorithms 214 stored in the algorithm database 212, which may utilize at least one of: transaction data, approved authorization request data, e-commerce session data, consumer data, account data, device data, etc.

In step 408, the processing unit 204 may optimize the declined authorizations 210 based on the identified fraud or chargeback scores. In step 410, the processing unit 204 may identify if the chargeback ratio exceeds the chargeback threshold. If the ratio does not, then, in step 412, the transmitting unit 206 may force post the clearing record for the next declined authorization 210 in line based on the optimization. In step 414, the processing unit 204 may update the forecasted chargeback ratio based on the force post cleared transaction and then return to step 410. Updating of the forecasted chargeback ratio may include estimation of variance and standard deviation of the ratio. Once the forecasted chargeback ratio exceeds the chargeback threshold, then, in step 416, the remaining declined authorizations 210 may be denied for force post clearing.

### Exemplary Method for Force Post Clearing Transactions

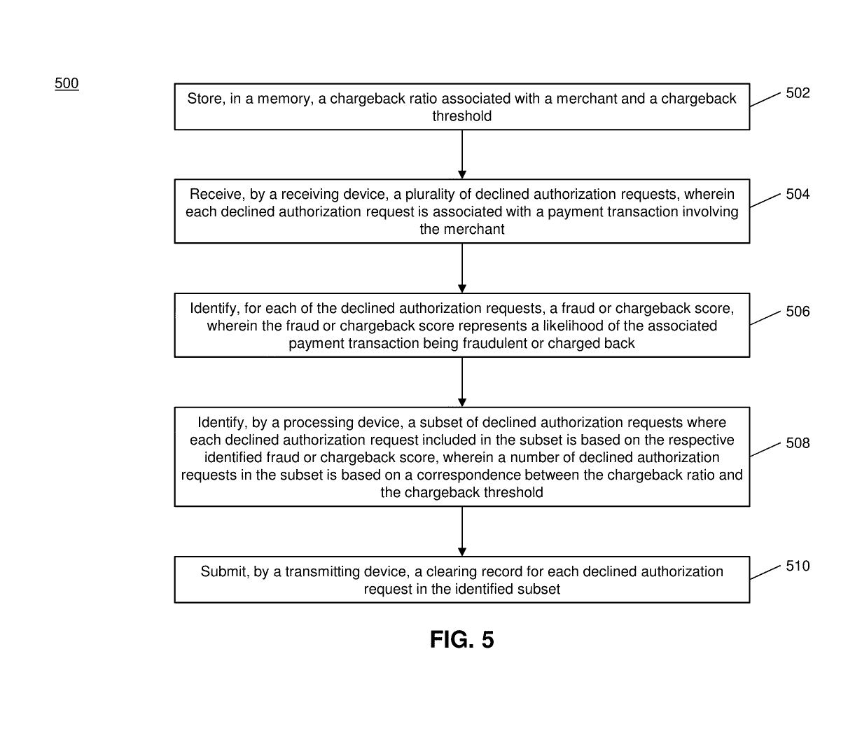

FIG. 5 illustrates an exemplary method 500 for force post clearing transactions using optimization based on fraud or chargeback scores.

In step 502, a chargeback ratio associated with a merchant (e.g., the merchant 104) and a chargeback threshold may be stored in a memory (e.g., the memory 216). In some embodiments, the chargeback ratio may correspond to a ratio of chargebacks to total transactions for the associated merchant 104.

In step 504, a plurality of declined authorization requests (e.g., declined authorizations 210) may be received by a receiving device (e.g., the receiving unit 202), wherein each declined authorization request 210 is associated with a payment transaction involving the merchant 104. In one embodiment, each declined authorization request 210 may include at least a time and/or date, wherein the included time and/or date is within a predetermined period of time.

In step 506, a fraud or chargeback score may be identified for each of the declined authorization requests 210, wherein the fraud or chargeback score represents a likelihood of the associated payment transaction being fraudulent or charged back. In some embodiments, each declined authorization request 210 may include transaction data, wherein the identified fraud or chargeback score for each declined authorization request 210 is based on at least the transaction data included in the respective declined authorization request 210. In a further embodiment, the fraud or chargeback score may be further based on at least one of: e-commerce session data, historical account data, and device data.

In one embodiment, one or more fraud algorithms (e.g., fraud algorithms 214) may be stored in the memory 216, wherein each declined authorization request includes transaction data, and the identified fraud or chargeback score for each declined authorization request is based on application of the stored one or more fraud algorithms 214 to the transaction data included in the respective declined authorization request 210. In a further embodiment, the one or more fraud algorithms 214 may be further applied to at least one of: approved authorization requests and fraud data.

In step 508, a subset of declined authorization requests 210 may be identified, by a processing device (e.g., the processing unit 20), where each declined authorization request 210 included in the subset is based on the respective identified fraud or chargeback score, wherein a number of declined authorization requests 210 in the subset is based on a correspondence between the chargeback ratio and the chargeback threshold. In one embodiment, the subset of declined authorization requests 210 may be identified using one or more optimization models. In a further embodiment, the one or more optimization models may include at least one of: linear programming, integer programming, and non-linear programming.

In some embodiments, each declined authorization request 210 may include at least a transaction amount, and the subset of declined authorization requests 210 may be further based on the transaction amount included in each respective declined authorization request 210. In other embodiments, each declined authorization request 210 may include at least a transaction amount, and the subset of declined authorization requests 210 may be further based on the transaction amount divided by a probability of the associated payment transaction being a fraudulent or chargeback transaction.

In step 510, a clearing record for each declined authorization request 210 in the identified subset may be submitted by a transmitting device (e.g., the transmitting unit 206). In one embodiment, the method 500 may further include estimating, by the processing device 204, the chargeback ratio associated with the merchant 104 for storage in the memory 216.

### Computer System Architecture

FIG. 6 illustrates a computer system 600 in which embodiments of the present disclosure, or portions thereof, may be implemented as computer-readable code. For example, the processing server 108 of FIG. 1 may be implemented in the computer system 600 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3-5.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 618, a removable storage unit 622, and a hard disk installed in hard disk drive 612.

Various embodiments of the present disclosure are described in terms of this example computer system 600. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 604 may be a special purpose or a general purpose processor device. The processor device 604 may be connected to a communications infrastructure 606, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 600 may also include a main memory 608 (e.g., random access memory, read-only memory, etc.), and may also include a secondary memory 610. The secondary memory 610 may include the hard disk drive 612 and a removable storage drive 614, such as a floppy disk drive, a magnetic tape drive, an optical disk drive, a flash memory, etc.

The removable storage drive 614 may read from and/or write to the removable storage unit 618 in a well-known manner. The removable storage unit 618 may include a removable storage media that may be read by and written to by the removable storage drive 614. For example, if the removable storage drive 614 is a floppy disk drive or universal serial bus port, the removable storage unit 618 may be a floppy disk or portable flash drive, respectively. In one embodiment, the removable storage unit 618 may be non-transitory computer readable recording media.

In some embodiments, the secondary memory 610 may include alternative means for allowing computer programs or other instructions to be loaded into the computer system 600, for example, the removable storage unit 622 and an interface 620. Examples of such means may include a program cartridge and cartridge interface (e.g., as found in video game systems), a removable memory chip (e.g., EEPROM, PROM, etc.) and associated socket, and other removable storage units 622 and interfaces 620 as will be apparent to persons having skill in the relevant art.

Data stored in the computer system 600 (e.g., in the main memory 608 and/or the secondary memory 610) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art. [0060]The computer system 600 may also include a communications interface 624. The communications interface 624 may be configured to allow software and data to be transferred between the computer system 600 and external devices. Exemplary communications interfaces 624 may include a modem, a network interface (e.g., an Ethernet card), a communications port, a PCMCIA slot and card, etc. Software and data transferred via the communications interface 624 may be in the form of signals, which may be electronic, electromagnetic, optical, or other signals as will be apparent to persons having skill in the relevant art. The signals may travel via a communications path 626, which may be configured to carry the signals and may be implemented using wire, cable, fiber optics, a phone line, a cellular phone link, a radio frequency link, etc. [0061]The computer system 600 may further include a display interface 602. The display interface 602 may be configured to allow data to be transferred between the computer system 600 and external display 630. Exemplary display interfaces 602 may include high-definition multimedia interface (HDMI), digital visual interface (DVI), video graphics array (VGA), etc. The display 630 may be any suitable type of display for displaying data transmitted via the display interface 602 of the computer system 600, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 608 and secondary memory 610, which may be memory semiconductors (e.g., DRAMs, etc.). These computer program products may be means for providing software to the computer system 600. Computer programs (e.g., computer control logic) may be stored in the main memory 608 and/or the secondary memory 610. Computer programs may also be received via the communications interface 624. Such computer programs, when executed, may enable computer system 600 to implement the present methods as discussed herein. In particular, the computer programs, when executed, may enable processor device 604 to implement the methods illustrated by FIGS. 3-5, as discussed herein. Accordingly, such computer programs may represent controllers of the computer system 600. Where the present disclosure is implemented using software, the software may be stored in a computer program product and loaded into the computer system 600 using the removable storage drive 614, interface 620, and hard disk drive 612, or communications interface 624.

Techniques consistent with the present disclosure provide, among other features, systems and methods for the conditional force posting of clearing records. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for force posting clearing transactions, comprising:
storing, in a memory, a chargeback ratio associated with a merchant and a chargeback threshold;
receiving, by a receiving device, a plurality of declined authorization requests, wherein each declined authorization request is associated with a payment transaction involving the merchant;
identify, for each of the received declined authorization requests, a fraud or chargeback score, wherein the fraud or chargeback score represents a likelihood of the associated payment transaction being fraudulent or charged back;
identifying, by a processing device, a subset of declined authorization requests where each declined authorization request included in the subset is based on the respective identified fraud or chargeback score, wherein a number of declined authorization requests in the subset is based on a correspondence between the chargeback ratio and the chargeback threshold; and
submitting, by a transmitting device, a clearing record for each declined authorization request in the identified subset.

2. The method of claim 1, wherein the chargeback ratio corresponds to a ratio of chargebacks to total transactions for the associated merchant.

3. The method of claim 1, wherein each declined authorization request includes at least a time and/or date, and wherein the included time and/or date is within a predetermined period of time.

4. The method of claim 1, wherein each declined authorization request includes transaction data, and wherein the identified fraud or chargeback score for each declined authorization request is based on at least the transaction data included in the respective declined authorization request.

5. The method of claim 1, further comprising:
storing, in the memory, one or more fraud algorithms, wherein
each declined authorization request includes transaction data, and
the identified fraud or chargeback score for each declined authorization request is based on application of the stored one or more fraud algorithms to the transaction data included in the respective declined authorization request.

6. The method of claim 1, wherein the subset of declined authorization requests is identified using one or more optimization models.

7. The method of claim 6, wherein the one or more optimization models includes at least one of: linear programming, integer programming, and non-linear programming.

8. The method of claim 1, wherein
each declined authorization request includes at least a transaction amount, and
the subset of declined authorization requests is further based on the transaction amount included in each respective declined authorization request.

9. The method of claim 1, wherein
each declined authorization request includes at least a transaction amount, and
the subset of declined authorization requests is further based on the transaction amount divided by a probability of the associated payment transaction being a fraudulent or a chargeback transaction.

10. The method of claim 1, further comprising:
estimating, by the processing device, the chargeback ratio associated with the merchant for storage in the memory.

11. A system for force posting clearing transactions, comprising:
a memory configured to store a chargeback ratio associated with a merchant and a chargeback threshold;
a receiving device configured to receive a plurality of declined authorization requests, wherein each declined authorization request is associated with a payment transaction involving the merchant;
a processing device configured to
identify, for each of the received declined authorization requests, a fraud or chargeback score, wherein the fraud or chargeback score represents a likelihood of the associated payment transaction being fraudulent or charged back, and
identify a subset of declined authorization requests where each declined authorization request included in the subset is based on the respective identified fraud or chargeback score, wherein a number of declined authorization requests in the subset is based on a correspondence between the chargeback ratio and the chargeback threshold; and
a transmitting device configured to submit a clearing record for each declined authorization request in the identified subset.

12. The system of claim 11, wherein the chargeback ratio corresponds to a ratio of chargebacks to total transactions for the associated merchant.

13. The system of claim 11, wherein each declined authorization request includes at least a time and/or date, and wherein the included time and/or date is within a predetermined period of time.

14. The system of claim 11, wherein each declined authorization request includes transaction data, and wherein the identified fraud or chargeback score for each declined authorization request is based on at least the transaction data included in the respective declined authorization request.

15. The system of claim 11, wherein
the memory is further configured to store one or more fraud algorithms,
each declined authorization request includes transaction data, and
the identified fraud or chargeback score for each declined authorization request is based on application of the stored one or more fraud algorithms to the transaction data included in the respective declined authorization request.

16. The system of claim 11, wherein the subset of declined authorization requests is identified using one or more optimization models.

17. The system of claim 16, wherein the one or more optimization models includes at least one of: linear programming, integer programming, and non-linear programming.

18. The system of claim 11, wherein
each declined authorization request includes at least a transaction amount, and
the subset of declined authorization requests is further based on the transaction amount included in each respective declined authorization request.

19. The system of claim 11, wherein
each declined authorization request includes at least a transaction amount, and
the subset of declined authorization requests is further based on the transaction amount divided by a probability of the associated payment transaction being a fraudulent or chargeback transaction.

20. The system of claim 1, wherein the processing device is further configured to estimate the chargeback ratio associated with the merchant for storage in the memory.
